(19) United States
(12) Patent Application Publication
(10) Pub. No.: US 2014/0302247 A1
(43) Pub. Date: Oct. 9, 2014

(54) METHOD OF FORMING DENSIFIED LAYER IN SPRAY COATING, AND SPRAY COATING COVERING MEMBER

(71) Applicants: Mitsuharu Inaba, Hyogo (JP); Hiroki Yokota, Hyogo (JP)

(72) Inventors: Mitsuharu Inaba, Hyogo (JP); Hiroki Yokota, Hyogo (JP)

(73) Assignee: TOCALO CO., LTD., Hyogo, (JP)

(21) Appl. No.: 14/355,053

(22) PCT Filed: Apr. 12, 2012
(86) PCT No.: PCT/JP2012/059996

§ 371 Date: Apr. 29, 2014

(30) Foreign Application Priority Data
Nov. 2, 2011 (JP) 2011-240867

(51) Int. Cl. B05D 3/06

(52) U.S. Cl. CPC B05D 3/06
USPC 427/493

(57) ABSTRACT

Forming a densified layer in a spray coating which forms a densified layer providing a sufficient effect while preventing generation of excessively large cracks and does not cause the increase of costs; also provided in a spray coating covering member. When a high-energy beam for remelting and resolidifying a coating composition of a surface layer of an Al₂O₃ spray coating is scanned over a surface of the Al₂O₃ spray coating, it is constituted with a precedent laser beam precedently scanned in a scanning direction and a follow-up laser beam subserviently scanned on the same trajectory as that of the precedent laser beam, and the precedent laser beam is irradiated on to the surface of the Al₂O₃ spray coating while scanning, and the follow-up laser beam is superimposedly irradiated to an irradiation region scanned with the precedent laser beam while scanning to thereby densify the surface layer of the irradiation region.

### TECHNICAL FIELD

The present invention relates to a method of forming a densified layer in a spray coating by forming a spray coating on a base member and remelting and resolidifying a surface layer of the spray coating to form a densified layer as well as a spray coating covering member coated with the spray coating.

### BACKGROUND ART

The spraying method is a surface treating technique wherein a powdery material of a metal, ceramic or the like is supplied into a burning flame or a plasma flame to render into a softened or melted state and sprayed onto a surface of a base member at a high speed to form a spray coating on the surface. As an application of the spraying method is mentioned the formation of a coating on a component member constituting a semiconductor manufacturing device such as CVD apparatus, PVD apparatus, a resist coating apparatus or the like. Generally, the process of manufacturing semiconductors, liquid crystal devices and the like has a problem that various members placed in a treating container are corroded because a treatment gas including a fluoride or a chloride is used in the treating container. Since the presence of particles generated in the treating container badly affects the quality and yield of products, it is absolutely necessary to reduce particles. To this end, a spray coating is formed on the component member by the spraying method, whereby the corrosion resistance thereof is improved and particles are reduced.

However, sufficient effect of corrosion resistance may not be necessarily obtained under such a condition that a severer corrosive gas is present or the like. In addition, generation of particles having a very small size, which have not been mentioned heretofore, is seen as a problem in the manufacturing process that continues to be downsized. Therefore, the surface of the spray coating formed on the base member is irradiated with a laser beam, whereby a coating composition of a surface layer of the spray coating is remelted and resolidified to render the surface layer into a densified layer. Thus, the corrosion resistance and the particle reducing effect are considerably improved (see, for example, Patent Document 1).

When the coating composition in the surface layer of the spray coating is remelted and resolidified with the laser beam as described above, cracks may be generated due to solidification/shrinkage of the surface layer. The presence of cracks does not have significant influences on the corrosion resistance and the particle reducing effect. If fine cracks are scattered, they act as a stress releasing mechanism and bring about the prevention of coating cracking or the like associated with thermal expansion. If cracks are excessively large, however, the corrosion resistance and the particle reducing effect are inversely impaired. For example, Patent Document 2 describes a method for surface treatment of a spray coating, in which the surface of the spray coating is irradiated with a laser beam having a wavelength of not less than 9 μm to prevent generation of cracks.

### PRIOR ART DOCUMENTS

### Patent Documents

Patent Document 1: JP-A-2007-247043

Patent Document 2: JP-A-2008-266724

### SUMMARY OF THE INVENTION

### Problems to be Solved by the Invention

In the method described in Patent Document 2, the surface layer is prevented from being excessively melted by setting the wavelength of the laser beam to not less than 9 μm. However, since a depth capable of being densified is only a slight part of the surface layer, the densified layer does not extend to a deeper part, and hence a sufficient effect of densification may not be obtained. In order to extend the densified layer to the deeper part, it is sufficient to lower the scanning speed of the laser beam. However, because of the surface treatment, the treating time is significantly prolonged, resulting in the increase of the cost or the generation of excessively large cracks passing through the spray coating.

Accordingly, in view of the problems of the conventional techniques described above, it is an object of the present invention to provide a method of forming a densified layer in a spray coating wherein the densified layer of a sufficient effect is formed while preventing generation of excessively large cracks without causing the increase of the cost as well as a spray coating covering member.

### Means for Solving the Problems

The following technical means are taken for achieving the above-described object.

The formation method of the densified layer in the spray coating according to the present invention is a method of forming a densified layer in a spray coating by forming a spray coating on a base member and irradiating a surface of the spray coating with a high-energy beam to remelt and resolidify a coating composition of a surface layer of the spray coating to thereby densify the surface layer, characterized in that when the high-energy beam is scanned over the surface of the spray coating, it is constituted with a precedent laser beam being precedently scanned in a scanning direction and a follow-up laser beam being subserviently scanned on the same trajectory as in the precedent laser beam, and the precedent laser beam is irradiated to the surface of the spray coating while scanning and the follow-up laser beam is superimposedly irradiated on an irradiation region scanned with the precedent laser beam while scanning to thereby densify a surface layer of the irradiation region.

In the method of forming a densified layer in a spray coating according to the present invention, the high-energy beam irradiated to the spray coating is constituted with the precedent being precedently scanned in the scanning direction and the follow-up laser beam being superimposedly scanned on the same trajectory as in the precedent laser beam, and the precedent laser beam is irradiated to the surface of the spray coating while scanning and the follow-up laser beam is superimposedly irradiated on the irradiation region scanned with the precedent laser beam while scanning to thereby densify the surface layer of the irradiation region. Accordingly, the densified layer is easily extended to the deeper part and sufficient effect of densification is obtained. It is not necessary to lower the scanning speed of the laser beam, and there is caused no increase of costs due to the prolongation of the treating time. Since the irradiation region is superimposedly irradiated with the precedent laser beam and the follow-up laser beam to remelt and resolidify the coating composition of the irradiation region, the morphological change of the coating composition becomes gentle. Consequently, the generation of excessively large cracks can be prevented.

It is preferable that each of the precedent laser beam and the follow-up laser beam has an energy density appropriate to one or more of plural steps in the process of remelting and resolidifying the coating composition. In this case, the morphological change in each step in the process of remelting and resolidifying the coating composition can be made optimum.

The formation method of the densified layer in the spray coating according to the present invention is a method of forming a densified layer in a spray coating by forming a spray coating on a base member and irradiating a surface of the spray coating with a high-energy beam to remelt and resolidify a coating composition of a surface layer of the spray coating to thereby densify the surface layer, characterized in that when the high-energy beam is scanned over the surface of the spray coating, it is constituted with a plurality of laser beams forming a plurality of beam spots in tandem on the surface in a scanning direction, and the plural laser beams are irradiated on the surface of the spray coating while scanning so as to sequentially pass the plural beam spots through the same irradiation region on the surface of the spray coating to thereby densify a surface layer of the irradiation region.

In the above method of forming the densified layer in the spray coating according to the present invention, the high-energy beam irradiating the spray coating is constituted with the plural laser beams forming a plurality of beam spots in tandem on the surface of the spray coating in the scanning direction, and the plural laser beams are irradiated on the surface of the spray coating while scanning so as to sequentially pass the plural beam spots through the same irradiation region on the surface of the spray coating to thereby densify the surface layer of the irradiation region. Therefore, the densified layer is easily extended to the deeper part and sufficient effect of densification is obtained. It is not necessary to lower the scanning speed of the laser beam, and there is caused no increase of costs due to the prolonging of the treating time. Since the beam spots of the plural laser beams are sequentially passed through the irradiation region to remelt and resolidify the coating composition of the irradiation region, the morphological change of the coating composition becomes gentle. Consequently, the generation of excessively large cracks can be prevented.

It is preferable that each of the plural laser beams has an energy density appropriate to one or more of the plural steps in the process of remelting and resolidifying the coating composition. In this case, the morphological change in each step in the process of remelting and resolidifying the coating composition can be made optimum.

Among the plural beam spots, two adjacent beam spots in the scanning direction may be partially overlapped to each other. In this case, the combined intensity distribution of the two adjacent laser beams in the scanning direction is continuous, and the morphological change of the coating composition is fitted to the intensity distribution.

The formation method of the densified layer in the spray coating according to the present invention is a method of forming a densified layer in a spray coating by forming a spray coating on a base member and irradiating a surface of the spray coating with a high-energy beam to remelt and resolidify a coating composition of a surface layer of the spray coating to thereby densify the surface layer, characterized in that when the high-energy beam is scanned over the surface of the spray coating, it is constituted with a plurality of laser beams forming a plurality of beam spots with the same width arranged side by side in a direction perpendicular to a scanning direction on the surface and sequentially shifted rearward in the scanning direction, and the plural laser beams arte irradiated onto the surface of the spray coating while scanning at such a state that an precedent beam spot anteceding toward the scanning direction and a follow-up beam spot followed thereto in the two adjacent beam spots among the plural beam spots are overlapped over a half or more of a spot region to each other in the perpendicular direction and the precedent beam spot and the subsequent follow-up beam spot are superimposedly passed through substantially a full region irradiated by the plural laser beams to densify a surface layer of the irradiation region.

In the method of forming the densified layer in the spray coating according to the present invention, the high-energy beam irradiating the spray coating is constituted with a plurality of laser beams forming a plurality of beam spots with the same width arranged side by side in a direction perpendicular to the scanning direction on the surface of the spray coating and sequentially shifted rearward in the scanning direction. The plural laser beams are irradiated to the surface of the spray coating while scanning at such a state that an precedent beam spot anteceding toward the scanning direction and a follow-up beam spot followed thereto in the two adjacent beam spots among the plural beam spots are overlapped over a half or more of a spot region to each other in the perpendicular direction and the precedent beam spot and the subsequent follow-up beam spot are superimposedly passed through substantially a full region irradiated by the plural laser beams to densify a surface layer of the irradiation region. Therefore, the densified layer is easily extended to the deeper part, and sufficient effect of densification is obtained. It is not necessary to lower the scanning speed of the laser beam, and there is caused no increase of costs due to the prolonging of the treating time. Further, since the surface of the spray coating is scanned with the plural laser beams forming beam spots arranged side by side, the treating time can be considerably reduced. Since the region to be irradiated is superimposedly irradiated with the precedent laser beam and the follow-up laser beam to remelt and resolidify the coating composition of the region, the morphological change of the coating composition becomes gentle. Consequently, the generation of excessively large cracks can be prevented.

The spray coating covering member of the present invention is a spray coating covering member comprising a base member and a spray coating covering a surface of the base member, characterized in that a surface layer of the spray coating is provided with a densified layer formed by remelting and resolidifying a coating composition, and the densified layer is formed by irradiating the surface of the coating sprayed on the base member with an precedent laser beam anteceding toward a scanning direction and superimposedly irradiating a follow-up laser beam following to the precedent laser beam while scanning on an irradiation region scanned with the precedent laser beam.

In the surface layer of the spray coating of the spray coating covering member of the present invention is formed the densified layer densified by superimposedly irradiating the precedent laser beam and the follow-up laser beam. Therefore, the densified layer is extended to the deeper part, and sufficient effect of densification is obtained. It is not necessary to lower the scanning speed of the laser beam, and there is caused no increase of costs due to the prolonging of the treating time. Since the densified layer is formed by superimposedly irradiating the precedent laser beam and the follow-up laser beam, the morphological change of the coating composition becomes gentle. Consequently, the generation of excessively large cracks can be prevented. As the spray coating is mentioned a spray coating made, for example, of an oxide-based ceramic material.

### Effects of the Invention

As described above, according to the present invention, the two laser beams are irradiated superimposedly, whereby the densified layer is easily extended to the deeper part and sufficient effect of densification can be obtained, and there is caused no increase of costs due to the prolonging of the treating time, and generation of excessively large cracks can be prevented because the morphological change of the coating composition becomes gentle.

### BRIEF DESCRIPTION OF THE DRAWINGS

FIG. 1 is a schematic view showing such a state that a transfer arm provided with a spray coating covering member according to one embodiment of the present invention is disposed in a semiconductor manufacturing device.

FIG. 2(a) is a perspective view of a transfer arm, and FIG. 2(b) is a schematically sectional view of a mounting member in the vicinity of its surface.

FIG. 3 is an outline view of a laser irradiation apparatus for irradiating a laser beam to a spray coating.

FIG. 4 is a schematic view showing such a state that a surface of a spray coating is scanned with a laser beam by using the formation method of a densified layer in a spray coating according to the first embodiment of the present invention.

FIG. 5(a) is a view showing an arrangement and intensity distribution of two beam spots on a surface of a spray coating, and FIGS. 5(b) to 5(d) are views showing an arrangement of two beam spots different from that in FIG. 5(a), respectively.

FIG. 6(a) is a photograph of a cross section of a surface layer when a surface of a spray coating is scanned with a high-energy beam in the example of FIG. 5(d), and FIG. 6(b) is a photograph of a cross section of a surface layer when the degree of overlap in the lateral direction is decreased, wherein each illustration on the right side of the photographs is a schematically sectional view thereof.

FIG. 7 is a view showing an arrangement of seven beam spots when a surface of a spray coating is scanned with seven laser beams by using the formation method of a densified layer in a spray coating according to the second embodiment of the present invention.

FIG. 8 is a view showing an arrangement of seven beam spots when a surface of a spray coating is scanned with seven laser beams by using the formation method of a densified layer in a spray coating according to the third embodiment of the present invention.

FIG. 9(a) is an electron microscope photograph of a cross section of a surface layer in an example, and FIG. 9(b) is an electron microscope photograph of a cross section of a surface layer in Comparative Example 1, and FIG. 9(c) is an electron microscope photograph of a cross section of a surface layer in Comparative Example 2.

### EMBODIMENTS FOR CARRYING OUT THE INVENTION

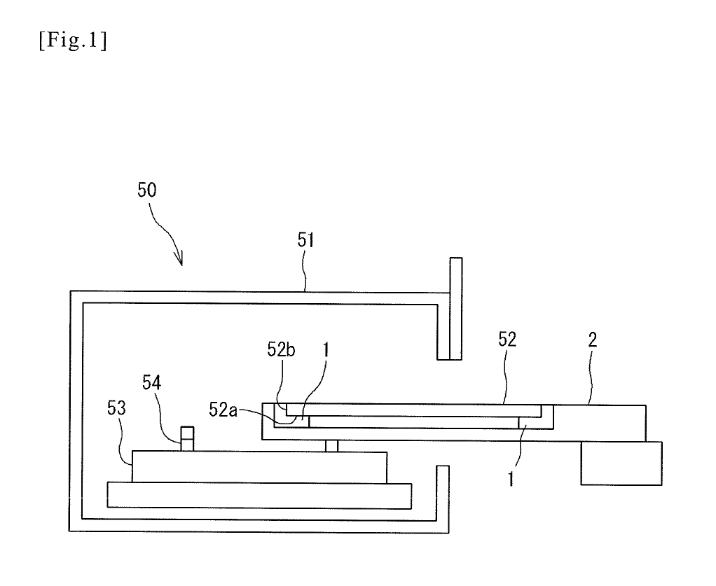

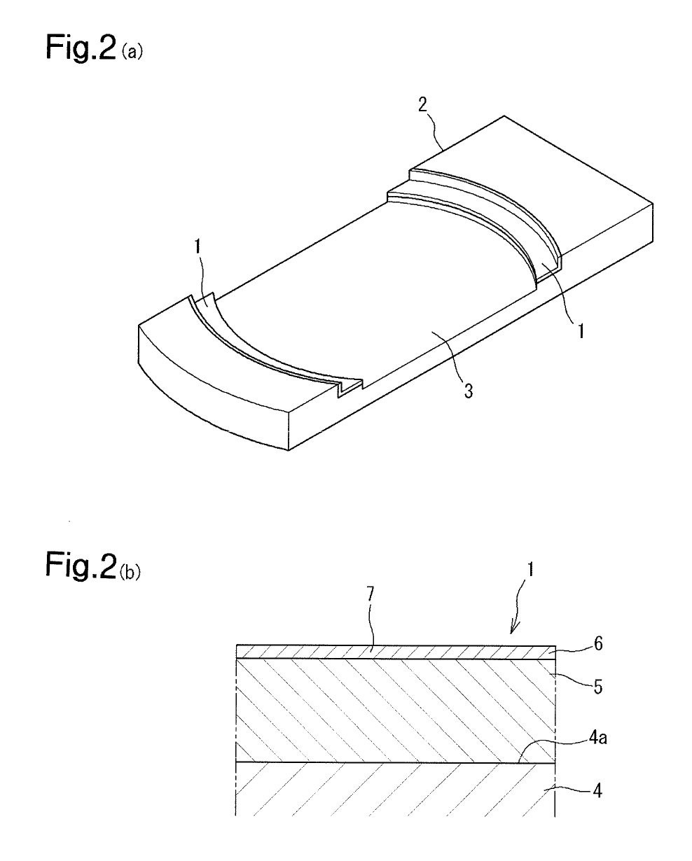

An embodiment of the present invention will be described below with reference to the drawings. FIG. 1 is a schematic view showing such a state that a transfer arm 2 provided with a spray coating covering member 1 according to one embodiment of the present invention is disposed in a semiconductor manufacturing device 50, and FIG. 2(a) is a perspective view of the transfer arm 2. As shown in FIG. 1, an electrostatic chuck 53 for holding a wafer 52 is disposed in a process chamber 51. When the wafer 52 is lifted from the electrostatic chuck 53 by a lifter pin 54, the transfer arm 2 is put into the chamber below the wafer 52 and then the lifter pin 54 is lowered to place the wafer 52 on the transfer arm 2, and thereafter the transfer arm 2 is removed from the process chamber 51 to transfer the wafer 52.

The transfer arm 2 is made of stainless steel, an aluminum alloy or the like, and has a long-plate shape as a whole. A concave holding portion 3 for holding the wafer 52 is formed in the transfer arm 2. At both ends of the holding portion 3 are disposed mounting members 1 as a spray coating covering member of L-shaped cross section constituting a part of the transfer arm 2, respectively. The wafer 52 is actually placed on the mounting members 1 so as to contact an edge portion 52a and a side surface 52b of the back surface of the wafer 52 therewith.

FIG. 2(b) is a schematically sectional view of the mounting member 1 in the vicinity of its surface. The mounting member 1 is constructed with a base member 4 made of stainless steel, an aluminum alloy or the like, and a ceramic spray coating 5 coated on a surface 4a of the base member 4 contacting with the wafer 52. The ceramic spray coating 5 of this embodiment is an Al₂O₃ spray coating 5. The Al₂O₃ spray coating 5 is formed by roughening the base member 4 through blasting, and then spraying Al₂O₃ spraying powder onto the roughened surface 4a of the base member 4 through an air plasma spraying method. Moreover, the spraying method for obtaining the Al₂O₃ spray coating 5 is not limited to the air plasma spraying method, but may be a reduced pressure plasma spraying method, a water plasma spraying method, or a high-speed and low-speed flame spraying method. Before the Al₂O₃ spraying powder is sprayed, an undercoat for enhancing adhesion to the base member 4 may be applied to the base member 4. As a material of the undercoat are used Al and an alloy thereof, Ni and an alloy thereof, Mo and an alloy thereof, and so on.

As the Al₂O₃ spraying powder are employed ones having a particle size range of 5 to 80 μm. When the particle size is less than 5 μm, the fluidity of the powder is deteriorated and the powder cannot be stably supplied, and hence the thickness of the coating becomes non-uniform, while when the particle size exceeds 80 μm, the coating is formed before the powder is fully melted, and made excessively porous, leading to rough coating quality.

The thickness of the Al₂O₃ spray coating 5 is preferable to be a range of 50 to 2000 μm. When the thickness is less than 50 μm, the uniformity of the spray coating 5 is deteriorated and the coating function cannot be sufficiently developed, while when it exceeds 2000 μm, the mechanical strength is lowered due to the influences of residual stress in the spray coating.

The Al₂O₃ spray coating 5 is a porous body, and the average porosity thereof is preferable to be a range of 5 to 10%. The average porosity varies depending on a spraying method and spraying conditions. When the porosity is less than 5%, residual stress existing in the Al₂O₃ spray coating 5 is increased, leading to reduce the mechanical strength. When the porosity exceeds 10%, various kinds of gases used in the semiconductor manufacturing process are easily penetrated into the Al₂O₃ spray coating 5, and the durability of the spray coating 5 is deteriorated.

In this embodiment, Al₂O₃ is employed as a material of the ceramic spray coating 5, but other oxide-based ceramics, nitride-based ceramics, carbide-based ceramics, fluoride-based ceramics, boride-based ceramics, and mixtures thereof may be employed. As a concrete example of other oxide-based ceramics are included TiO₂, SiO₂, Cr₂O₃, ZrO₂, Y₂O₃ and MgO. As the nitride-based ceramics are included TiN, TaN, AlN, BN, Si₃N₄, HfN and NbN. As the carbide-based ceramics are included TiC, WC, TaC, B₄C, SiC, HfC, ZrC, VC and Cr₃C₂. As the fluoride-based ceramics are included LiF, CaF₂, BaF₂ and YF₃. As the boride-based ceramics are included TiB₂, ZrB₂, HfB₂, VB₂, TaB₂, NbB₂, W₂B₅, CrB₂ and LaB₆.

A densified layer 7 is formed in a surface layer 6 of the Al₂O₃ spray coating 5 coated on the mounting member 1. The densified layer 7 is a ceramic recrystallized material formed by modifying porous Al₂O₃ in the surface layer 6 of the Al₂O₃ spray coating 5. The densified layer 7 is an Al₂O₃ recrystallized material formed by irradiating the Al₂O₃ spray coating 5 with a laser beam as a high-energy beam to heat porous Al₂O₃ in the surface layer 6 to its melting point or higher, and remelting and resolidifying it for modification. The crystal structure of the Al₂O₃ spray coating 5 before the irradiation of laser beam is in a mixed state of α-type and γ-type, and the crystal structure of the modified Al₂O₃ recrystallized material is almost only α-type.

The Al₂O₃ spray coating 5 is a porous body as described above, and has a stacked structure of many Al₂O₃ particles, wherein boundaries exist between Al₂O₃ particles. These boundaries are eliminated by irradiating the laser beam to remelt and resolidify the surface layer 6 of the Al₂O₃ spray coating 5, and the number of pores is decreased associated therewith. Therefore, the densified layer 7 made of the Al₂O₃ recrystallized material has a highly densified layer structure. Since the densified layer 7 forming the surface layer 6 of the Al₂O₃ spray coating 5 has a very dense structure in comparison with a surface layer not irradiated with the laser beam, the mechanical strength of, for example, the Al₂O₃ spray coating 5 is improved, and the durability to an external force acting on the mounting member 1 is remarkably improved.

In the case of the original Al₂O₃ spray coating not irradiated with the laser beam, if external force is applied, Al₂O₃ particles are detached from each other at boundaries existing between the particles and hence coating particles easily drop out. When the densified layer 7 is formed in the surface layer 6 of the Al₂O₃ spray coating 5 as in this embodiment, the dropout of coating particles due to existence of boundaries between Al₂O₃ particles can be reduced. Of course, particles generated from the base member 4 coated with the Al₂O₃ spray coating 5 can also be reduced. The effect of reducing the dropout of coating particles and base member particles by the formation of the densified layer 7 is sufficient for providing the good semiconductor manufacturing process, and the dropout of the particles can be prevented from affecting the process.

The thickness of the densified layer 7 is preferable to be not more than 200 μm. When the thickness is more than 200 μm, the residual stress of the remelted and resolidified surface layer becomes excessively large, and impact resistance to an external force is deteriorated, leading to rather decrease the mechanical strength. In addition, it is required to increase the output of the laser beam or take a long scanning time, which is inefficient and brings about the increase of production costs.

The average porosity of the densified layer 7 is preferably less than 5%, more preferably less than 2%. That is, it is important that a porous layer having an average porosity of 5 to 10% in the surface layer 6 of the Al₂O₃ spray coating 5 is made to a densified layer having an average porosity of less than 5% by the irradiation of laser beam, whereby there can be obtained the sufficiently densified layer 7 being less in the boundaries between Al₂O₃ particles.

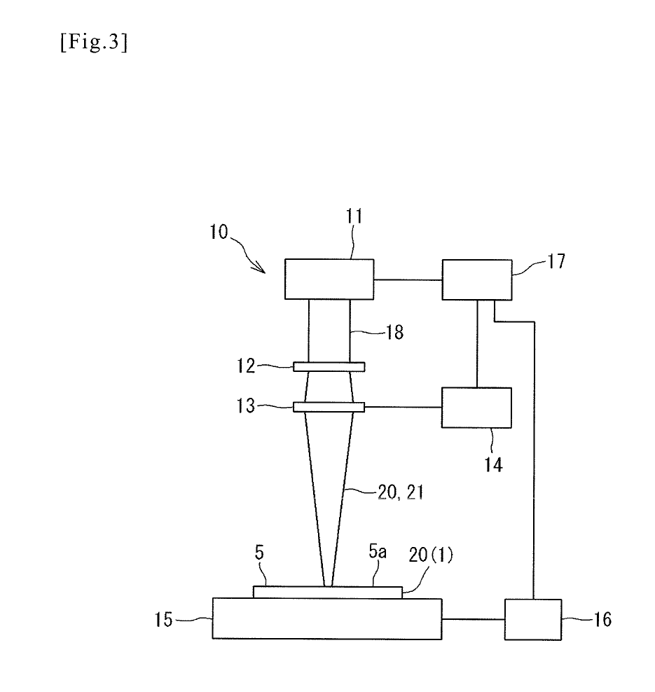

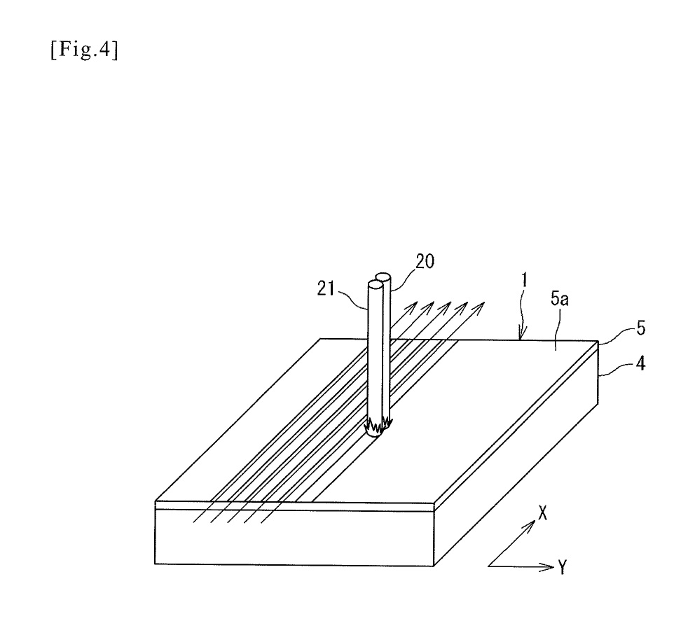

Next, a method of forming the densified layer 7 by irradiating a laser beam to the Al₂O₃ spray coating 5 coating the mounting member 1 will be described. FIG. 3 is an outline view of a laser irradiation apparatus 10 for irradiating the laser beam to the Al₂O₃ spray coating 5, and FIG. 4 is a schematic view showing such a state that the surface 5a of the Al₂O₃ spray coating 5 is scanned with the laser beam by using the method of forming the densified layer in the spray coating according to the first embodiment of the present invention. The laser irradiation apparatus 10 is mainly constructed with a laser oscillator 11, a DOE (Diffractive Optical Element) 12 as a diffractive optical element, a light collection optical system 13 for collecting a laser beam to a predetermined optical path, an adjustment device 14 for adjusting the position of the light collection optical system 13, an XY stage 15 for moving an object to be irradiated in an X direction and a Y direction, a drive portion 16 for driving the XY stage 15, and a control device 17 for controlling the laser oscillator 11, the adjustment device 14 and the drive portion 16.

The laser oscillator 11 emits a laser beam 18 based on a signal sent from the control device 17. The laser oscillator 11 is controlled by the control device 17, whereby the intensity, timing and the like of the laser beam 18 emitted from the laser oscillator 11 are adjusted. The laser beam 18 can be arbitrarily selected from common laser beams such as those of YAG laser, CO₂ laser and an excimer laser depending on an object to be irradiated and is not limited. The DOE 12 is an optical element for diffracting the laser beam 18 emitted from the laser oscillator 11 to shape into a predetermined beam form. In this embodiment, when the laser beam 18 as a high-energy beam emitted from the laser oscillator 11 is scanned over the surface 5a of the spray coating 5, it is branched by the DOE 12 into a precedent laser beam 20 being precedently scanned in a scanning direction (X axis direction) and a follow-up laser beam 21 being scanned following to the same trajectory as in the precedent laser beam 20.

The adjustment device 14 for adjusting the position of the light collection optical system 13 receives a signal from the control device 17 to change the position of the light collection optical system 13. The drive portion 16 for driving the XY stage 15 receives a signal from the control device 17 to drive the XY stage 15 in an X-axis direction and a Y-axis direction, whereby the scanning speeds of both the laser beams 20 and 21, timing for starting and ending movement of an object to be irradiated, and so on are adjusted. Thus, the irradiation object fixed on the XY stage 15 is moved toward the X-axis direction and the Y-axis direction in the horizontal plane, and both the laser beams 20 and 21 are scanned on the irradiation object. Moreover, the drive portion 16 can move the XY stage 15 not only in the horizontal direction, but also in a height direction (Z-axis direction) or an oblique direction forming a predetermined angle with respect to the horizontal direction.

Since the irradiation of both the laser beams 20 and 21 can be performed in air, the deoxidation phenomenon of Al₂O₃ is reduced. Depending on irradiation conditions of both the laser beams 20 and 21 may be caused deoxidation phenomenon even in air to blacken the spray coating. In such a case, deoxidation phenomenon can be avoided to prevent the blackening by blowing oxygen during the irradiation of both the laser beams 20 and 21 or by surrounding the periphery with a chamber or the like to create an atmosphere of high oxygen partial pressure. By adjusting these various conditions can be lowered the lightness of the Al₂O₃ spray coating 5, or the Al₂O₃ spray coating 5 can be kept white.

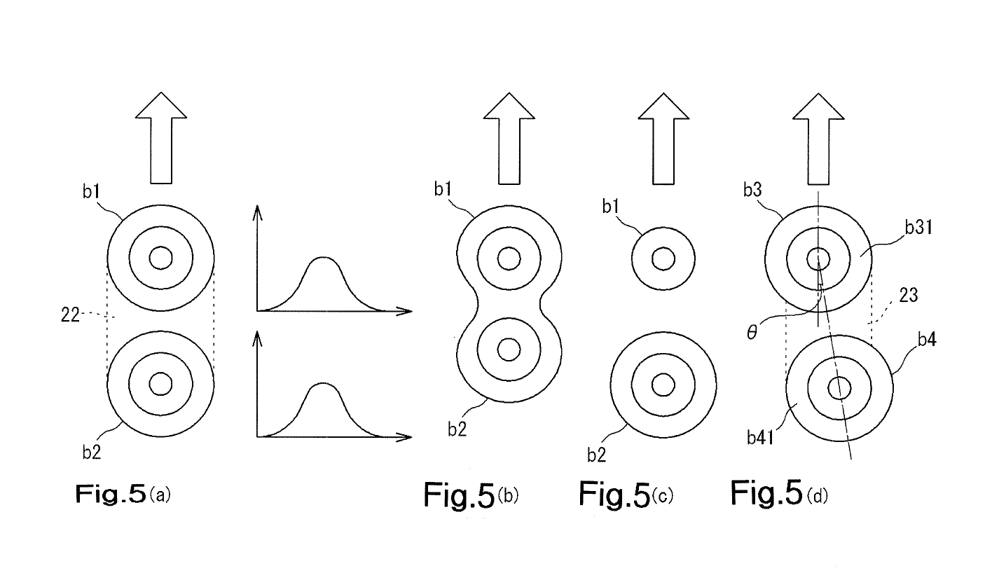

The mounting member 1 provided with the Al₂O₃ spray coating 5 is fixed on the XY stage 15 of the laser irradiation apparatus 10, and the precedent laser beam 20 and the follow-up laser beam 21 are irradiated onto the surface 5a of the spray coating 5 while scanning. FIG. 5(a) is a view showing an arrangement of a beam spot b1 of the precedent laser beam 20 and a beam spot b2 of the follow-up laser beam 21 on the surface 5a of the spray coating 5, and intensity distributions of both the laser beams 20 and 21. The ordinate of the intensity distribution represents an intensity and the abscissa thereof represents a distance in the radial direction.

The precedent laser beam 20 and the follow-up laser beam 21 are laser beams having the same intensity, and the beam spots b1 and b2 on the surface 5a of the spray coating 5 have the same size. The precedent laser beam 20 is precedently irradiated onto the surface 5a of the Al₂O₃ spray coating 5 while scanning, and the follow-up laser beam 21 subsequent to the precedent laser beam 20 is superimposed irradiated on the irradiated region 22 scanned with the precedent laser beam 20 while scanning. As shown in FIG. 5(a), the position of the beam spot b2 of the follow-up laser beam 21 is close to the position of the beam spot b1 of the precedent laser beam 20, and the irradiated region 22 scanned with the precedent laser beam 20 is scanned with the follow-up laser beam 21 immediately after the scanning with the precedent laser beam 20.

Since the follow-up laser beam 21 is scanned on the same trajectory as that of the precedent laser beam 20 and the beam spot b1 of the precedent laser beam 20 and the beam spot b2 of the follow-up laser beam 21 have the same size, the beam spot b2 of the follow-up laser beam 21 is superimposedly passed over the whole of the irradiation region 22 after the passing of the beam spot b1 of the precedent laser beam 20.

The scanning of the precedent laser beam 20 and the follow-up laser beam 21 onto the surface 5a of the Al₂O₃ spray coating 5 of the mounting member 1 is performed as follows (see FIG. 4). The XY stage 15 fixed with the mounting member 1 is moved, for example, in the X-axis direction while irradiating both the laser beams 20 and 21 collected by the light collection optical system 13, and the surface 5a of the Al₂O₃ spray coating 5 is scanned with the precedent laser beam 20 and the follow-up laser beam 21. After the scanning thereof is temporarily stopped the scanning, and the XY stage 15 is brought back to the original position along the X-axis direction and moved by a predetermined distance in the Y-axis direction. Then, the XY stage 15 is moved again in the X-axis direction while irradiating both the laser beams 20 and 21, whereby a different part of the surface 5a of the Al₂O₃ spray coating 5 is centrally scanned with the precedent laser beam 20 and the follow-up laser beam 21. By repeating the scanning over the surface 5a of the Al₂O₃ spray coating 5 covering the mounting member 1 is formed the densified layer 7 on the surface layer 6 of the Al₂O₃ spray coating 5.

The formation of the densified layer 7 by superimposedly irradiating the precedent laser beam 20 and the follow-up laser beam 21 on the surface 5a of the Al₂O₃ spray coating 5 will be described below. Ceramic materials generally have a low thermal conductivity, and ceramic spray coatings are still lower in the thermal conductivity. In a ceramic sintered material are bonded ceramic particles together, whereas the ceramic spray coating has a stacked structure of many particles as mentioned above, in which boundaries exist between the particles. This is considered to be a cause of lowering the thermal conductivity.

On the other hand, the densified layer of the ceramic spray coating is required to have a sufficient depth, a small ablation amount, a less crack, a high mechanical strength, a high smoothness and the like, so that a high-quality spray coating covering member can be obtained by uniting these requirements. In order to form a densified layer uniting these requirements, it is required to make optimum morphological change in plural steps of heating, melting, retaining and deepening of a melted state and cooling on the way of remelting and resolidifying the coating composition.

To this end, the intensity of the laser beam, the size of the beam spot and the scanning speed must be adjusted to appropriate conditions to strictly control the energy density of the laser beam irradiated to the coating composition. However, if it is actually intended to increase the energy density of the laser beam by enhancing the intensity of the laser beam or decreasing the size of the beam spot or delaying the scanning speed, since the thermal conductivity of the ceramic spray coating is low as described above, heat is not diffused and hence heat is locally concentrated. When heat is locally concentrated, ablation is caused, and not only the coating composition is not sufficiently melted, but also considerable thickness reduction occurs. Conversely, if it is intended to decrease the energy density of the laser beam by decreasing the intensity of the laser beam or increasing the size of the beam spot or increasing the scanning speed, thermal expansion of the surface layer is caused by heating a wide area, leading to cause rupture of the ceramic spray coating as a fragile material. In addition, since the light energy absorption rate of the ceramic spray coating rises at a melted state, even if the heating can be performed initially, non-melting state is continued. Once melting starts, the coating is rapidly melted. Therefore, it is very difficult to adjust the above-described various conditions of the laser beam to make optimum the morphological change in plural steps of heating, melting, retaining and deepening of a melted state and cooling to thereby provide a densified layer satisfying the above requirements.

In this embodiment, each of the precedent laser beam 20 and the follow-up laser beam 21 superimposedly irradiating the surface 5a of the Al₂O₃ spray coating 5 has an energy density appropriate to one or more of the plural steps on the way of remelting and resolidifying the Al₂O₃ composition. Among the plural steps of heating, melting, retaining and deepening of a melted state and cooling, the heating and melting of the coating composition are performed with the precedent laser beam 20, and the retaining and deepening of a melted state and the cooling are performed with the follow-up laser beam 21. It is considered that the morphological change from the heating to the melting by the precedent laser beam 20 is performed instantaneously at the time of the irradiation and the retaining and deepening of a melted state by the follow-up laser beam 21 proceeds as long as the irradiation is continued. As to the cooling by the follow-up laser beam 21, the intensity of the peripheral part of the beam spot b2 is lower than the intensity of the central part thereof as shown in FIG. 5(a), and slow cooling is conducted in the peripheral part finally passing the beam. By especially conducting slow cooling with the follow-up laser beam 21 is made low the solidification speed of the melted coating composition, whereby a good crystal structure can be formed.

Since both the laser beams 20 and 21 actually have beam spots b1 and b2 having the same intensity and size, the heating and melting are performed with one of the laser beams having the same energy density, while the retaining and deepening of a melted state and the cooling are performed with the other. By dividing and assigning roles to each of both the laser beams 20 and 21 can be optimized the morphological change in the plural steps of heating, melting, retaining and deepening of a melted state and cooling.

In the method of forming the densified layer in the spray coating according to the above embodiment, the high-energy beam irradiating to the Al₂O₃ spray coating 5 is constructed with the precedent laser beam 20 being precedently scanned in the scanning direction and the follow-up laser beam 21 being subserviently scanned on the same trajectory as that of the precedent laser beam 20, and the precedent laser beam 20 is irradiated to the surface 5a of the Al₂O₃ spray coating 5 while scanning and the follow-up laser beam 21 is superimposedly irradiated onto the irradiation region 22 scanned with the precedent laser beam 20 while scanning to thereby densify the surface layer 6 of the irradiation region 22. Accordingly, the densified layer 7 is easily extended to the deeper part, and the sufficient effect of densification is obtained. Also, it is not necessary to decrease the scanning speeds of both the laser beams 20 and 21, so that there is not caused the increase of costs due to the prolongation of the treating time. Since the irradiation region 22 is superimposedly irradiated with the precedent laser beam 20 and the follow-up laser beam 21 to remelt and resolidify the coating composition of the irradiation region 22, the morphological change of the coating composition becomes gentle. Consequently, the generation of excessively large cracks can be prevented.

By dividing and assigning steps of melting to cooling of the coating composition to each of both the laser beams 20 and 21 can be made optimum the morphological change in the steps. Since a sufficient thickness of the densified layer 7 is secured, the durability of the Al₂O₃ spray coating 5 is improved, and the ablation amount of the Al₂O₃ spray coating 5 can be reduced to achieve a high mechanical strength of the Al₂O₃ spray coating 5, and further the smooth surface can be formed. Therefore, the mounting member 1 can be coated with the Al₂O₃ spray coating 5 having the densified layer 7 of such excellent properties as the surface layer 6.

The arrangement, size and shape of each of the beam spots b1 and b2 of the precedent laser beam 20 and the follow-up laser beam 21 scanned on the same trajectory as in the precedent laser beam are not limited. FIGS. 5(b) and 5(c) are views each showing arrangements of both the beam spots b1 and b2 different from those described above. As shown in FIG. 5(b), a part of the beam spot b1 of the precedent laser beam 20 and a part of the beam spot b2 of the follow-up laser beam 21 may be overlapped to each other. In this case, the combined intensity distribution of both the laser beams 20 and 21 in the scanning direction is continuous, and the morphological change of the coating composition is fitted to the intensity distribution.

As shown in FIG. 5(c), the beam spot b1 of the precedent laser beam 20 may be made smaller than the beam spot b2 of the follow-up laser beam 21. In this case, the combined intensity distribution of both the laser beams 20 and 21 in a direction perpendicular to the scanning direction (referred to as a lateral direction hereinafter) is different from the combined intensity distribution of beam spots having the same size. Also, the shape of either one or both of the beam spots may be changed. In the above embodiment, the both beam spots are circular, but both or one of the beam spots may be made to have an elliptical shape which is long in the scanning direction, the lateral direction or any other direction. Further, the both beam spots may have a shape other than the above circular and elliptical shapes. The intensity distribution from the central portion to the peripheral portion of the both beam spots b1 and b2 may be changed by changing outputs or the like of the both laser beams 20 and 21. In this embodiment, the heating and melting of the coating composition are performed with the precedent laser beam 20, and the retaining and deepening of the melted state and the cooling are performed with the follow-up laser beam 21, but steps different from the above embodiment with the both laser beams 20 and 21 may be performed, for example, by heating the coating composition with the precedent laser beam 20 and performing the melting, retaining and deepening of the melted state and cooling with the follow-up laser beam 21.

When being scanned over the surface 5a of the Al₂O₃ spray coating 5, the high-energy beam may be constituted with a plurality of laser beams forming plural beam spots arranged in tandem in the scanning direction on the surface 5a, in which the plural laser beams are irradiated onto the surface 5a while scanning so as to sequentially pass the plural beam spots through the same irradiation region on the surface 5a of the Al₂O₃ spray coating 5 to thereby densify a surface layer of the irradiation region. As a specific example of irradiating such plural laser beams is mentioned a case that two or more laser beams are arranged on the same trajectory in the scanning direction or shifted in the lateral direction thereto, including the case of using the precedent laser beam 20 and the follow-up laser beam 21 scanned on the same trajectory followed thereto as in the above embodiment.

In FIG. 5(d) is shown a specific example that the precedent laser beam and the follow-up laser beam scanned followed thereto are arranged so as to be shifted in the lateral direction. In this example, a part b41 of a beam spot b4 of the follow-up laser beam among the two laser beams arranged in the scanning direction is superimposedly passed through a region 23 irradiated by passing a part b31 of a beam spot b3 of the precedent laser beam. When the two laser beams are arranged so as to be shifted in the lateral direction, an angle θ formed by the follow-up laser beam with respect to the precedent laser beam is less than 90°. In this example, the precedent laser beam and the follow-up laser beam are overlapped to each other over 80% of a spot region in the lateral direction.

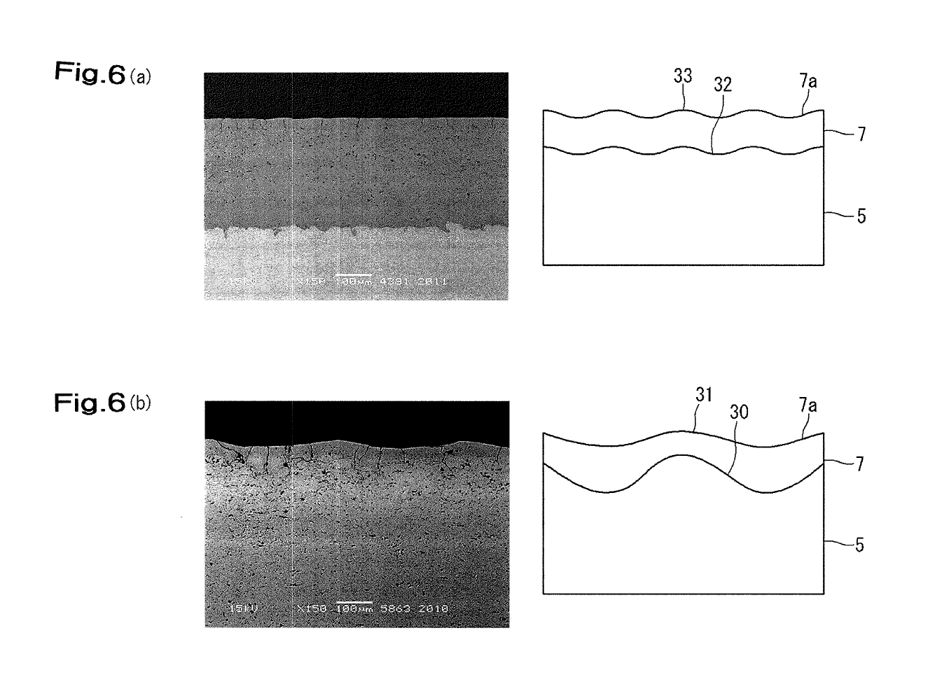

FIG. 6(a) is a photograph of a cross section of a surface layer when the surface 5a of the Al₂O₃ spray coating 5 is scanned with a high-energy beam in the example of FIG. 5(d), and FIG. 6(b) is a photograph of a cross section of a surface layer when the degree of overlapping the precedent laser beam and the follow-up laser beam in the lateral direction is made smaller than that in the example of FIG. 5(d) (15% of the spot region), and the illustration on the right side of each photograph is a schematically sectional view thereof.

When the degree of overlapping the both laser beams is small (FIG. 6(b)), an undulation is generated at a surface 7a of a densified layer 7 or at a boundary portion 30 between the densified layer 7 and the non-densified layer 5 to increase the variation in the thickness of the densified layer 7. A mountain portion 31 of the undulation at the surface 7a of the densified layer 7 is a portion contacting with a wafer 52, but the thickness of the densified layer 7 in this portion 31 becomes thin as is apparent from the schematic view, and it is difficult to obtain a sufficient effect by the formation of the densified layer 7. On the other hand, when the degree of overlapping the both laser beams is large (FIG. 6(a)), an undulation at the surface 7a of the densified layer 7 or at a boundary portion 32 between the densified layer 7 and the non-densified layer 5 is small, and the variation in the thickness of the densified layer 7 is small. As is apparent from the schematic view, the thickness of the mountain portion 33 of the undulation at the surface 7a of the densified layer 7 is not thin, and a sufficient effect by the formation of the densified layer 7 is obtained.

As another configuration, the laser beams may be three, four or more so that they are arranged on the same trajectory in the scanning direction or arranged so as to be shifted in the lateral direction. When the plural laser beams are arranged so as to be shifted in the lateral direction, for example, they may be not only arranged in one direction obliquely but also arranged so as to meander to left and right along the scanning direction.

Even when the plural laser beams are used as described above, the densified layer is easily extended to the deeper part, and a sufficient effect by the densification is obtained. Also, it is not necessary to decrease the scanning speeds of the plural laser beams, and there is not caused the increase of costs due to the prolongation of the treating time. Since the plural laser beams are superimposedly irradiated onto the irradiation region 23 to remelt and resolidify the coating composition of the irradiation region 23, the morphological change of the coating composition becomes gentle. Consequently, the generation of excessively large cracks can be prevented. Since the sufficient thickness of the densified layer is secured, the durability of the Al₂O₃ spray coating is improved, and the ablation amount of the Al₂O₃ spray coating can be reduced to achieve a high mechanical strength of the Al₂O₃ spray coating, and further the smooth surface can be formed.

Each of the plural laser beams is sufficient to have an energy density appropriate to one or more steps among plural steps in the process of remelting and resolidifying the coating composition. That is, the heating and melting of the coating composition among the plural steps comprising the heating, melting, retaining and deepening of a melted state and cooling are performed with the precedent laser beam, and the retaining and deepening of the melted state and the cooling are performed with the follow-up laser beam, or the first laser beam, for example, among three laser beams performs the heating, and the second laser beam performs the melting, retaining and deepening of the melted state, and the third laser beam performs the cooling. Four laser beams may be used to further subdivide the plural steps. Even in this case, the morphological change in a plurality of steps including the heating, melting, retaining and deepening of a melted state and cooling can be made optimum by dividing and assigning roles to each of the plural laser beams.

The arrangement, size and shape of beam spots in the plural laser beams are not limited. The two beam spots adjacent in the scanning direction may be partially overlapped with each other. In this case, the combined intensity distribution of the both laser beams in the scanning direction becomes continuous. In the plural laser beams, the beam spot sizes may be made different. The shape of the plural beam spots can be changed into an elliptical shape being long in the scanning direction, the lateral direction or any other direction. Further, the plural beam spots may be made to have a shape other than the circular and elliptical shapes. The intensity distribution from the central portion to the peripheral portion in the plural beam spots may be changed by changing outputs or the like of the plural laser beams.

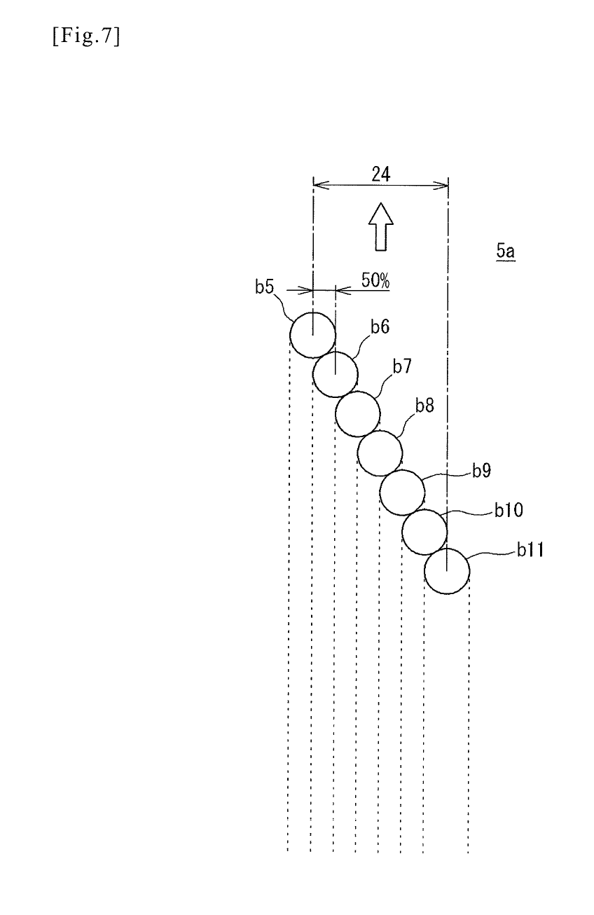

FIG. 7 is a view showing an arrangement of seven beam spots when the surface 5a of the spray coating 5 formed on the mounting member 1 is scanned with seven laser beams by using a method of forming a densified layer in a spray coating according to the second embodiment of the present invention. The schematically sectional view of the mounting member 1 in the vicinity of its surface is similar to FIG. 2(b). The method of forming a densified layer in a spray coating according to this embodiment uses seven laser beams forming first to seventh beam spots b5 to b11 with the same width in the order from the leftmost end along the scanning direction as shown in FIG. 7. In this embodiment are generated seven laser beams to form the first to seventh beam spots b5 to b11, but the number of laser beams and the number of beam spots formed are not limited. The seven laser beams form the beam spots b5 to b11 having the same intensity and same size on the surface 5a of the spray coating 5.

When the first to seventh beam spots b5 to b11 are scanned over the surface 5a of the spray coating 5, they are arranged side by side in the lateral direction on the surface 5a and shifted one after another rearward in the scanning direction. The second beam spot b6 is shifted in the lateral direction and rearward in the scanning direction with respect to the first beam spot b5, and subsequently the third beam spot b7 is shifted in the lateral direction and rearward in the scanning direction with respect to the second beam spot b6. Similarly, each of the fourth, fifth, sixth and seventh beam spots b8 to b11 is arranged so as to be shifted in the lateral direction and rearward in the scanning direction with respect to the previous one.

The first beam spot b5 and the second beam spot b6, the second beam spot b6 and the third beam spot b7, the third beam spot b7 and the fourth beam spot b8, the fourth beam spot b8 and the fifth beam spot b9, the fifth beam spot b9 and the sixth beam spot b10, and the sixth beam spot b10 and the seventh beam spot b11 overlap with each other in the lateral direction over 50% of the spot region, respectively.

That is, as regards an irradiation region 24 overlapping two adjacent beam spots in the lateral direction, the first beam spot b5 is a precedent beam spot preceding in the scanning direction with respect to the second beam spot b6, and the second beam spot b6 is a follow-up beam spot followed thereto. At the same time, as regards the irradiation region 24, the second beam spot b6 is a precedent beam spot with respect to the third beam spot b7, and the third beam spot b7 is a follow-up beam spot followed thereto. Similarly, the third, fourth, fifth and sixth beam spots b7 to b10 are precedent beam spots with respect to the subsequent beam spots b8 to b11, respectively, and at the same time, the fourth, fifth, sixth and seventh beam spots b8 to b11 are follow-up beam spots with respect to the precedent beam spots b7 to b10, respectively.

Since the precedent beam spot and the follow-up beam spot overlap with each other over 50% of the spot region in the lateral direction, when the seven laser beams forming the first to seventh beam spots b5 to b11 are irradiated on the surface 5a of the Al₂O₃ spray coating 5 while scanning, the follow-up beam spot subsequent to the precedent beam spot can be superimposedly passed through substantially the whole region 24 irradiated with the seven laser beams.

The scanning of the seven laser beams on the surface 5a of the Al₂O₃ spray coating 5 of the mounting member 1 is performed likewise the first embodiment as follows. The XY stage 15 fixed to the mounting member 1 is moved, for example, in an X axis direction while irradiating seven laser beams collected by the light collection optical system 13, whereby the surface 5a of the Al₂O₃ spray coating 5 is scanned with the seven laser beams, and after the scanning is temporarily stopped, the XY stage 15 is returned to the original position along the X axis direction and moved by a predetermined distance in the Y axis direction. Then, the XY stage 15 is moved again in the X axis direction while irradiating seven laser beams, whereby a different portion of the surface 5a of the Al₂O₃ spray coating 5 is focusingly scanned with the seven laser beams. By repeating the above scanning over the surface 5a of the Al₂O₃ spray coating 5 is formed the densified layer 7 on the surface layer 6 of the Al₂O₃ spray coating 5.

Even in this embodiment, each of the precedent laser beam and the follow-up laser beam superimposedly irradiating the surface 5a of the Al₂O₃ spray coating 5 has an energy density appropriate to one or more steps among the plural steps in the process of remelting and resolidifying the coating composition. That is, the heating and melting of the coating composition among the plural steps including the heating, melting, retaining and deepening of a melted state and cooling are performed with the precedent laser beam, and the retaining and deepening of the melted state and the cooling are performed with the follow-up laser beam.

Since each laser beam is not only a precedent laser beam but also a follow-up laser beam, the each laser beam forms beam spots having the same intensity and size on the surface 5a of the Al₂O₃ spray coating 5 as in this embodiment. The heating and melting are performed with one of laser beams having the same energy density, and the retaining and deepening of the melted state and the cooling are performed with the other. By dividing and assigning roles to each of the both laser beams as described above can be made optimum the morphological change in the plural steps including the heating, melting, retaining and deepening of a melted state and cooling.

In the method of forming a densified layer in a spray coating according to this embodiment, the high-energy beam irradiating the Al₂O₃ spray coating 5 is constituted with a plurality of laser beams forming the plural beam spots b5 to b11 with the same width arranged side by side on the surface 5a of the Al₂O₃ spray coating 5 and shifted one after another rearward in the scanning direction. The plural laser beams are irradiated on the surface 5a of the Al₂O₃ spray coating 5 while scanning at such a state that mutually adjoining precedent beam spot and follow-up beam spot followed thereto are overlapped to each other over a half or more of a spot region in the lateral direction, whereby the precedent laser beam and subsequently the follow-up laser beam are superimposedly passed through substantially the whole region 24 irradiated with the plural laser beams to densify the surface layer 6 of the irradiation region 24.

Therefore, the densified layer 7 is easily extended to the deeper part, and a sufficient effect by the densification is obtained. Also, it is not necessary to decrease the scanning speeds of the plural laser beams, and there is not caused the increase of costs due to the prolongation of the treating time. Further, the surface 5a of the Al₂O₃ spray coating 5 is scanned with the plural laser beams forming the beam spots b5 to b11 arranged side by side, so that the treating time can be considerably reduced. Since the precedent laser beam and the following laser beam are superimposedly irradiated to remelt and resolidify the coating composition, the morphological change of the coating composition becomes gentle. Consequently, the generation of excessively large cracks can be prevented.

By dividing and assigning plural steps of from melting to cooling of the coating composition to each of the two adjoining laser beams among the plural laser beams arranged side by side can be made optimum the morphological change in the steps. Since a sufficient thickness of the densified layer 7 is secured, the durability of the Al₂O₃ spray coating 5 is improved and the ablation amount of the Al₂O₃ spray coating 5 can be reduced. Further, a high mechanical strength of the Al₂O₃ spray coating 5 is achieved, and a smooth surface can be formed. Therefore, the mounting member 1 can be coated with the Al₂O₃ spray coating 5 having the densified layer 7 of such excellent properties as the surface layer.

In the above embodiment, the precedent beam spot and the follow-up beam spot are overlapped with each other over 50% of a spot region in the lateral direction, but the overlapping degree may be not less than 50% but not more than 100%. When the overlapping degree is less than 50%, there remains an area which cannot be superimposedly irradiated with the follow-up laser beam.

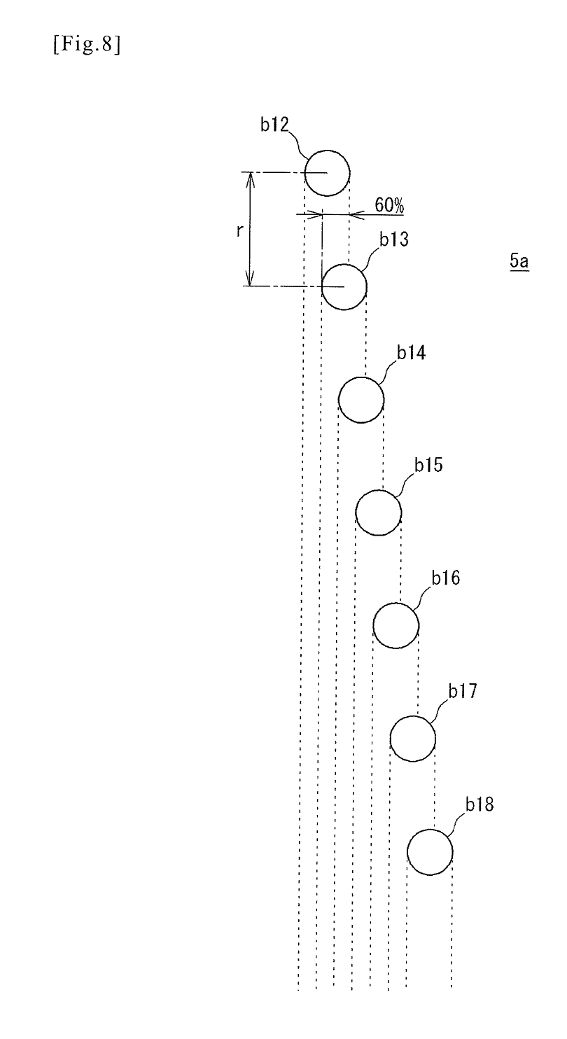

FIG. 8 is a view showing an arrangement of seven beam spots when the surface 5a of the Al₂O₃ spray coating 5 formed on the mounting member 1 is scanned with seven laser beams by using a method of forming a densified layer in a spray coating according to the third embodiment of the present invention. In this embodiment, the mutual precedent beam spot and follow-up beam spot among seven beam spots b12 to b18 arranged side by side are at a state of overlapping to each other over 60% of a spot area in the lateral direction.

The center-to-center distance r between the precedent beam spot and the follow-up beam spot in the scanning direction is 2.5 times the diameter of the beam spot.

In this embodiment, therefore, the overlapping degree between the precedent beam spot and the follow-up beam spot in the lateral direction is greater than that of the second embodiment, and the center-to-center distance r in the scanning direction is larger than that of the second embodiment. In this case, the plural steps of from melting to cooling of the coating composition can be divided and assigned to each of two laser beams forming the precedent beam spot and the follow-up beam spot as a matter of course, and the morphological change in the steps can be made different from that of the second embodiment.

### EXAMPLE

The present invention will be described in detail by way of an example. Moreover, the present invention is not limited to the following example. As the example, one surface of a flat plate A 6061 of 100×100×5 mm is coated with an Al₂O₃ spray coating in a thickness of 200 μm with a plasma spraying method and irradiated with a plurality of CO₂ laser beams by the method of the second embodiment. The overlapping degree over a spot region in the lateral direction between the adjoining precedent beam spot and follow-up beam spot is 66%. As Comparative Examples 1 and 2, one surface of a flat plate A 6061 of 100×100×5 mm is coated with an Al₂O₃ spray coating in a thickness of 200 μm with a plasma spraying method and irradiated with a single CO₂ laser beam.

The irradiation conditions in the example and Comparative Examples 1 and 2 are as follows.

(Example) number of beams: 7, laser output: 20 W (2.9 W×7), laser beam area: 0.2 mm² (0.029 mm²×7), treating speed: 10 mm/s.

(Comparative Example 1) number of beams: 1, laser output: 20 W, laser beam area: 0.2 mm, treating speed: 10 mm/s.

(Comparative Example 2) number of beams: 1, laser output: 3 W, laser beam area: 0.03 mm², treating speed: 10 mm/s.

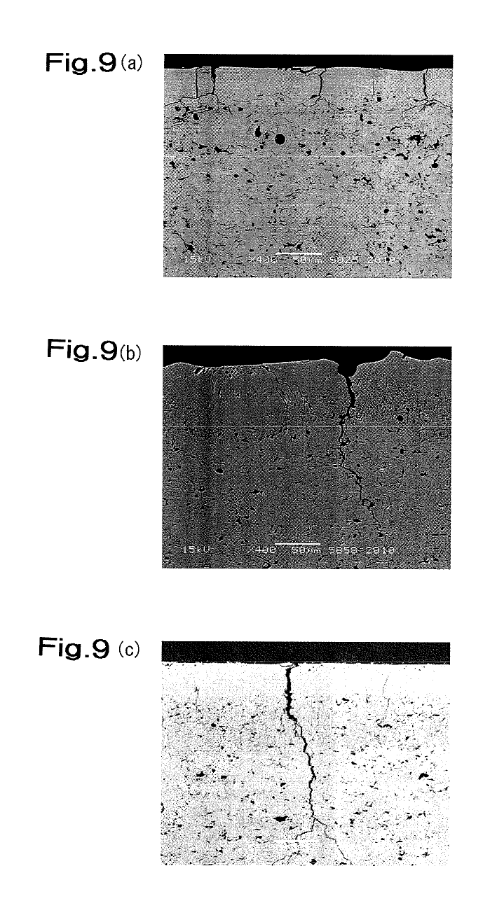

FIG. 9(a) is an electron microscope photograph of a cross section of a surface layer in the example, and FIG. 9(b) is an electron microscope photograph of a cross section of a surface layer in Comparative Example 1, and FIG. 9(c) is an electron microscope photograph of a cross section of a surface layer in Comparative Example 2. The thickness of a densified layer is 25 μm and the crack depth is 40 μm in the example, while the thickness of a densified layer is 20 to 50 μm and the crack depth is 200 μm in Comparative Example 1, and the thickness of a densified layer is 25 μm and the crack depth is 200 μm in Comparative Example 2.

The embodiments disclosed above are illustrative and not restrictive. For example, a plurality of beam spots may be formed from a plurality of laser beams without using DOE. In this case, different kinds of laser beams may be used, for example, a CO₂ laser is used as a precedent laser beam and a YAG laser is used as a follow-up laser beam depending on the conditions of the coating composition to be melted and so on. As to the scanning system with laser beams, the scanning may be performed by moving the XY stage in one direction (going direction) and then moving in the opposite direction (returning direction), rather than movement in only one direction. The XY stage may be moved not only linearly but also rotationally. Further, the laser beam side may be moved using a galvano lens rather than moving the scanning object side with the XY stage. The intensity of the laser beam, the size of the beam spot, the scanning speed, the intensity distribution of the beam spots, the irradiation angle of the laser beam and so on can be changed properly. The spray coating covering member coated with a spray coating having a densified layer formed by the method of the present invention is not limited, and may be any of component members constituting semiconductor manufacturing devices such as CVD apparatuses, PVD apparatuses and resist coating apparatuses, and various kinds of members used in other apparatuses and industrial products.

### DESCRIPTION OF REFERENCE SYMBOLS

1 Mounting member

2 Transfer arm

4 Base member

5 Al₂O₃ spray coating

5a Surface

6 Surface layer

7 Densified layer

10 Laser irradiation apparatus

11 Laser oscillator

12 DOE

13 Light collection optical system

15 XY stage

20 Precedent laser beam

21 Follow-up laser beam

22, 23, 24 Irradiation region

b1 to b18 Beam spots

1. A method of forming a densified layer in a spray coating by forming a spray coating on a base member and irradiating a surface of the spray coating with a high-energy beam to remelt and resolidify a coating composition of a surface layer of the spray coating to thereby densify the surface layer, characterized in that when the high-energy beam is scanned over the surface of the spray coating, it is constituted with an precedent laser beam being precedently scanned in a scanning direction and a follow-up laser beam being subserviently scanned on the same trajectory as in the precedent laser beam, and the precedent laser beam is irradiated to the surface of the spray coating while scanning and the follow-up laser beam is superimposedly irradiated on an irradiation region scanned with the precedent laser beam while scanning to thereby densify a surface layer of the irradiation region.

2. The method of forming a densified layer in a spray coating according to claim 1, wherein each of the precedent laser beam and the follow-up laser beam has an energy density appropriate to one or more steps among plural steps in the process of remelting and resolidifying the coating composition.

3. A method of forming a densified layer in a spray coating by forming a spray coating on a base member and irradiating a surface of the spray coating with a high-energy beam to remelt and resolidify a coating composition of a surface layer of the spray coating to thereby densify the surface layer, characterized in that when the high-energy beam is scanned over the surface of the spray coating, it is constituted with a plurality of laser beams forming a plurality of beam spots in tandem on the surface in a scanning direction, and the plural laser beams are irradiated on the surface of the spray coating while scanning so as to sequentially pass the plural beam spots through the same irradiation region on the surface of the spray coating to thereby densify a surface layer of the irradiation region.

4. The method of forming a densified layer in a spray coating according to claim 3, wherein each of the plural laser beams has an energy density appropriate to one or more steps among plural steps in the process of remelting and resolidifying the coating composition.

5. The method of forming a densified layer in a spray coating according to claim 3 or 1, wherein two adjoining beam spots among the plurality of beam spots in the scanning direction are partially overlapped with each other.

6. A method of forming a densified layer in a spray coating by forming a spray coating on a base member and irradiating a surface of the spray coating with a high-energy beam to remelt and resolidify a coating composition of a surface layer of the spray coating to thereby densify the surface layer, characterized in that when the high-energy beam is scanned over the surface of the spray coating, it is constituted with a plurality of laser beams forming a plurality of beam spots with the same width arranged side by side in a direction perpendicular to a scanning direction on the surface and sequentially shifted rearward in the scanning direction, and the plural laser beams are irradiated onto the surface of the spray coating while scanning at such a state that an precedent beam spot anteceding toward the scanning direction and a follow-up beam spot followed thereto in the two adjacent beam spots among the plural beam spots are overlapped over a half or more of a spot region to each other in the perpendicular direction and the precedent beam spot and the subsequent follow-up beam spot are superimposedly passed through substantially a full region irradiated by the plural laser beams to densify a surface layer of the irradiation region.

7. A spray coating covering member comprising a base member and a spray coating covering a surface of the base member, characterized in that a surface layer of the spray coating is provided with a densified layer formed by remelting and resolidifying a coating composition, and the densified layer is formed by irradiating the surface of the coating sprayed on the base member with an precedent laser beam anteceding toward a scanning direction and superimposedly irradiating a follow-up laser beam following to the precedent laser beam while scanning on an irradiation region scanned with the precedent laser beam.

8. The spray coating covering member according to claim 7, wherein the spray coating is made of an oxide-based ceramic material.

9. The method of forming a densified layer in a spray coating according to claim 4, wherein two adjoining beam spots among the plurality of beam spots in the scanning direction are partially overlapped with each other.
